(19) United States
(12) Patent Application Publication
(10) Pub. No.: US 2009/0095402 A1
(43) Pub. Date: Apr. 16, 2009

(54) METHOD AND APPARATUS FOR CONTROLLING THE POWER OUTPUT OF A RADIO FREQUENCY SEALING MACHINE

(75) Inventors: William Alfred Hall, Tega Cay, SC (US); Patrick John Hall, Rock Hill, SC (US)

Correspondence Address: McClure Law Firm, PLLC, 9815 Sam Furr Rd., Suite J, #202, Huntersville, NC, 28078, US

(73) Assignee: HALL DIELECTRIC MACHINERY COMPANY, INC., Rock Hill, SC (US)

(21) Appl. No.: 12/252,844

(22) Filed: Oct. 16, 2008

Related U.S. Application Data
(60) Provisional application No. 60/980,289, filed on Oct. 16, 2007.

(51) Int. Cl. B32B 37/06

(52) U.S. Cl. 156/64; 156/379.6

(57) ABSTRACT

The present invention provides a radio frequency welding apparatus for joining multiple layers of thermoplastic materials. The apparatus includes an electrical voltage source that is electrically connected to a radio frequency energy generator. The apparatus also includes a first die and a second die that are configured to form a tooling capacitor when thermoplastic sheets to be welded are positioned between them. The tooling capacitor is electrically connected to the radio frequency energy generator and the dielectric includes a thermoplastic sheet. A processor is electrically connected to the voltage source and is configured to monitor an electrical property applied to the electric circuit and vary voltage supplied to the radio frequency generator such that the electrical property approaches a predetermined value. The radio frequency energy generator is configured to provide energy to the tooling capacitor such the energy can be controlled as the voltage is controlled.

### CLAIM OF PRIORITY

The present application claims priority from provisional U.S. Patent Application No. 60/980,289 filed on Oct. 16, 2007 which is incorporated herein by reference.

### FIELD OF THE INVENTION

The present invention relates to an improved apparatus and method for welding thermoplastic materials, and more particularly to an apparatus and a method for joining two or more thin sheets of thermoplastic materials along a welded seam.

### BACKGROUND OF THE INVENTION

Radio Frequency (RF) welding, also known as RF heat sealing, high frequency sealing, and dielectric heat sealing, is used to produce many types of products by welding together thin thermoplastic sheets. The thermoplastic sheets can be formed of vinyl, polyvinyl chloride (PVC), and polyurethane. Many products can be produced with RF welding including medical products such as blood bags, catheters, and compression sleeves. RF welding can be used to form many different structures including interior welded seams, edge welded seams, and folds such as those that form hinges. Products formed with RF welding can also include one or more gas or fluid retaining bladders created by interior welded seams that are selectively formed on the thermoplastic sheets.

A conventional RF welding machine includes an RF energy generator, or oscillator, that is electrically connected to a first capacitor that is electrically connected to a second capacitor. The first capacitor includes two spaced-apart plates, or sheets, of a conductive material such as aluminum that define a gap. A dielectric such as air is positioned in the gap between the two plates. The second capacitor includes top and bottom dies separated by the thermoplastic layers to be welded. The thermoplastic layers function as a dielectric of the second capacitor.

In operation, the RF generator generates energy at a frequency sufficient to heat the portions of the thermoplastic that contact the bottom and top dies. When these portions are heated to their melting points, the heated portions of the thermoplastic sheets flow together. Then the thermoplastic is allowed to cool and solidify to form a weld. The configuration of the weld is generally determined by the shape of the die.

The amount of energy delivered via the dies to the thermoplastic to be welded is determined by the amount of voltage applied to the RF generator and the current within the circuit. Thus, there are two inputs into the power output of an RF welding machine: voltage and current. In conventional RF welding machines only one of these inputs, current, is varied to control the energy, or power, that is applied to the thermoplastic.

Several problems are associated with the conventional control used in RF welding. One problem is that the capacitance of the first capacitor can vary because of the varying properties of the dielectric, i.e., air, that is positioned within the gap. In this regard, at a first air temperature and humidity, the first capacitor will have a first capacitance at a particular gap. But the capacitance will be different at a second temperature or humidity even though the gap has not changed. Thus the capacitance of the first capacitor may vary even though the gap width is constant.

Another problem is that the incoming voltage to the RF generator may vary due to changes in incoming line load. Variation of the incoming voltage will also cause variation of the output of the first capacitor even though the gap is fixed.

Another problem associated with conventional control systems of RF welding machines is that the variation of power due to variation of the current or voltage described above can not be directly determined.

Another problem associated with conventional RF welding machines is that the capacitance of the second capacitor may vary during the welding process due to changes of the electrical properties of the thermoplastic that occurs as the thermoplastic melts.

The present invention addresses these problems by providing an RF welding apparatus and a method for controlling the apparatus wherein variations within the process due to variations in the electrical properties of the circuit are compensated for. Such electrical properties include, but are not limited to: voltage, current, and capacitance.

### SUMMARY OF THE INVENTION

Accordingly, there is provided a method and apparatus for controlling an RF welding machine for joining two or more thin sheets of thermoplastic materials along a welded seam wherein variations of power applied to a thermoplastic material to be welded are reduced relative to variations in conventional processes.

Another object of the present invention is to provide a radio frequency sealing apparatus and method for joining two or more thin thermoplastic sheets along a welded seam having excellent seam integrity.

Another object of the present invention is to provide a radio frequency sealing apparatus and method for welding two or more thermoplastic layers together while maintaining the power applied to the thermoplastic during the welding process generally constant.

Another object of the present invention is to provide a radio frequency sealing apparatus and method for efficiently tuning the RF circuit to generate a predetermined RF frequency for welding two layers of thermoplastic material.

Another object of the present invention is to provide a radio frequency sealing apparatus and method for controlling the power applied to the thermoplastic to be welded wherein the voltage applied to the RF generator is monitored and controlled.

Another object of the present invention is to provide a radio frequency sealing apparatus and method for controlling the power applied to the thermoplastic to be welded wherein the current applied to the first capacitor is monitored and the voltage supplied to the RF generator is controlled.

Another object of the present invention is to provide a radio frequency sealing apparatus and method for providing a generally constant power to the thermoplastic plastic to be welded when electrical properties of the thermoplastic to be welded vary.

Another object of the present invention is to provide a radio frequency sealing apparatus and method for providing a generally constant power to the thermoplastic plastic to be welded when electrical properties of the thermoplastic to be welded vary as the thermoplastic is heated during the welding process.

Another object of the present invention is to provide a radio frequency sealing apparatus and method for sealing using a very low power.

Another object of the present invention is to provide a radio frequency sealing apparatus and method for sealing wherein the power can be varied through a wide range.

Another object of the present invention is to provide a radio frequency sealing apparatus and method wherein the voltage is controlled in real time.

Another object of the present invention is to provide a radio frequency sealing apparatus and method wherein variations in voltage to the RF generator are compensated for.

Another object of the present invention is to provide a radio frequency sealing apparatus and method wherein a frequency drive is used to control the voltage provided to the RF generator.

Another object of the present invention is to provide a radio frequency sealing apparatus and method wherein contacts used to interrupt the flow of electricity at the end of a cycle are closed at the beginning of the cycle when no load is present.

Another object of the present invention is to provide a radio frequency sealing apparatus and method wherein a step starter is used.

### BRIEF DESCRIPTION OF THE DRAWINGS

The foregoing and other objects will become more readily apparent by referring to the following detailed description and the appended drawings in which:

FIG. 1 is an elevation view of an apparatus for welding thermoplastic materials according to a preferred embodiment of the present invention;

FIG. 2 is a schematic electrical diagram of an embodiment of the present invention;

FIG. 3 is a schematic electrical diagram of the embodiment shown in FIG. 2 further schematically showing the mechanical components of the contactor, the first capacitor, and the second capacitor; and

FIG. 4 is a flow diagram showing steps of a method according to one embodiment of the present invention.

### DETAILED DESCRIPTION OF THE PREFERRED EMBODIMENTS

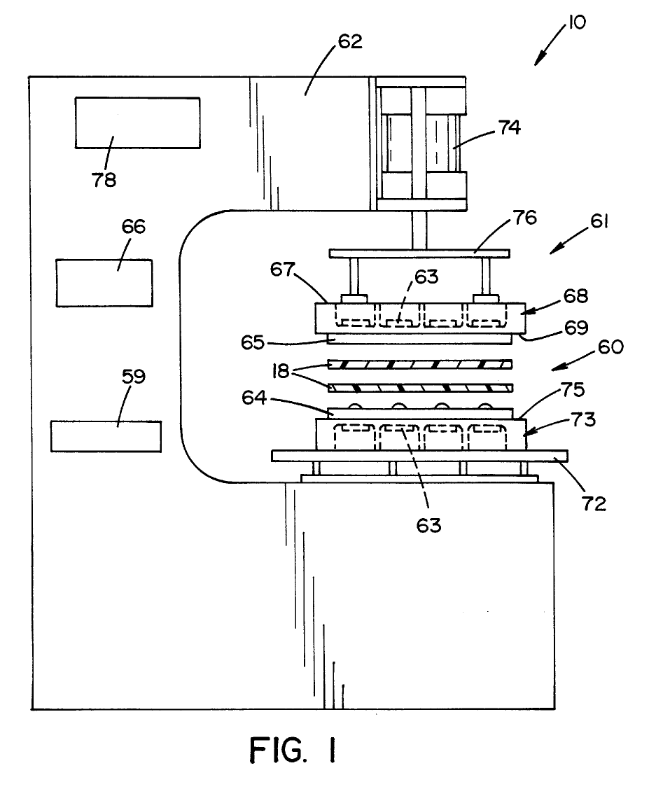

Referring now to the drawings, an apparatus 10 for joining two or more thin thermoplastic sheets along a welded seam according to the invention is shown in FIG. 1. As used herein, the term “thermoplastic” refers to polyolefins, polyurethanes, vinyls, polyvinyl chlorides (PVCs), and other thermoplastic elastomers. The term “thin thermoplastic sheets” as used herein is not intended to be limited, other than by practicality, to any particular thickness. For example, thermoplastic foils, films, webs, wraps, mats, and laminates are equally applicable to the apparatus and method of the invention. The sheets may be similar or dissimilar thermoplastic materials. However, for the purpose of describing the preferred embodiments disclosed herein, the sheets are the same thermoplastic material, namely a polyolefin such as polypropylene.

As best shown in FIG. 1, the apparatus 10 includes a welding assembly 60. Welding assembly 60 includes a lower platen 73 and an upper platen 68. Upper platen 68 is configured substantially similarly to lower platen 73 and can be understood from a description thereof. The lower platen 73 is formed of a thick (relative to the thin thermoplastic sheets), generally rigid material, such as 1.5 inch aluminum plate stock, which exhibits good heat conductivity and heat retention. The lower platen 73 may be any size and shape that is practical for a given application, but preferably conforms to the outer dimensions of the thermoplastic sheets to be welded on the welding assembly 60.

In a preferred embodiment, a welding first die 64 is fixed to the surface 75 of the lower platen 73. The lower platen 73 is configured to be heated by a heating means 63.

The upper platen 68 comprises an outwardly facing surface 67 that is fixed to an upper support plate, or press bolster, 76 for rigidly attaching the upper platen 68 to the pressing means 74. The upper platen further comprises an inwardly facing surface 69. A second die 65 is attached to surface 69.

The apparatus 10 further includes an oscillator 78 configured to generate energy and electrically connected to the first die 64 and the second die 65. A frame 62 is configured to support the welding assembly 60, the oscillator 78 and a processor 66. A lower support plate 72, or press bolster, is attached to the frame 62 and is configured to support the lower platen 73 and the first die 64. A means 63 is provided for heating each of upper platen 68 and lower platen 73.

As shown in FIG. 1, oscillator 78 is a conventional RF energy transducer configured to generate variable intensity RF energy. The intensity of the RF energy produced by oscillator 78 can be varied by the control means 66, as described hereinafter. Preferably, the RF energy transducer generates RF energy waves having a frequency range from about 1 to about 100 Mhz, and preferably generates RF energy waves having a frequency of about 27.12 Mhz.

The processor 66 is configured to control the operation of the welding assembly 60, including activating and deactivating the welding press 61 and the oscillator 78.

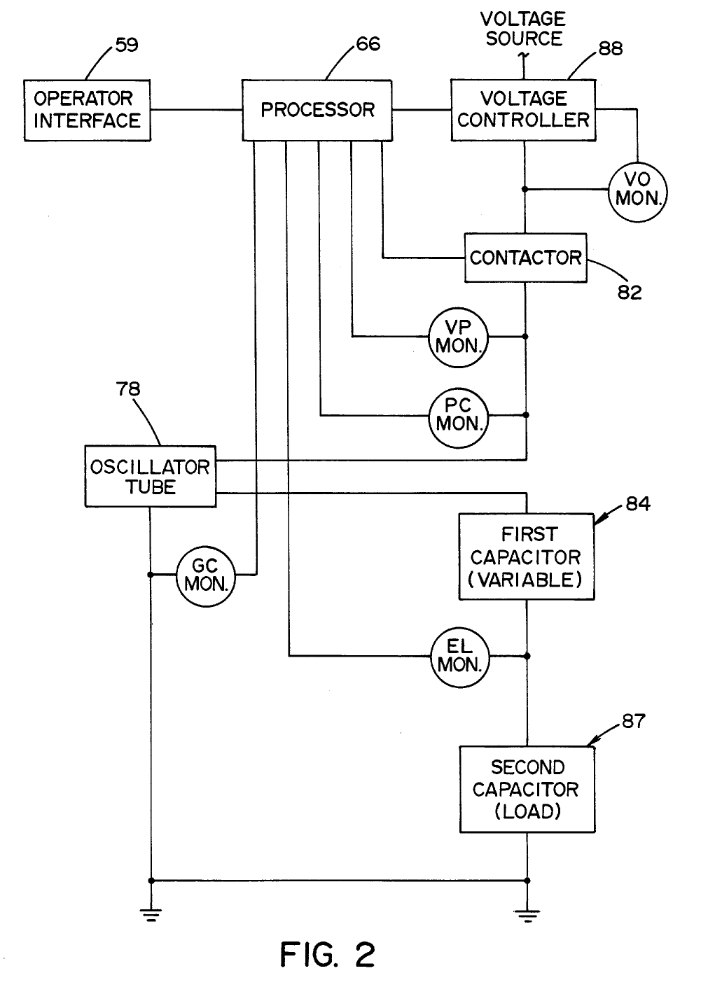

Referring now to FIG. 2 that schematically shows the electrical components provided for generating and controlling RF energy of the present invention, the radio frequency welding machine, apparatus 50, includes a control means 66, a contactor 82, the oscillator 78, a first capacitor 84, and a second capacitor 87. The processor 66 can be a programmable logic controller (PLC) or other similar device that includes a means for controlling the amount of voltage provided to oscillator 78. In this regard, processor 66 is electrically connected to a voltage controller 88 and processor 66 is configured to provide voltage set points to voltage controller 88. Stated another way, processor 66 is configured to control voltage by providing appropriate voltage setpoints to voltage controller 88 and voltage controller 88 directly controls voltage based on the signals provided by control means 66. Processor 66 is electrically connected to an operator interface 59. Operator interface 59 is configured to communicate the status of apparatus 10 to and operator and is configured to receive instructions from an operator via conventional methods. Such methods include but are not limited to touch screen, key pad, key board, verbal instructions, audible signals, visual signals and the like.

Contactor 82 is electrically positioned between the voltage controller 88 and the oscillator 78. The contactor 82 is movable between a closed first position that is configured conduct a flow of electricity to the oscillator tube 78 and an open second position for preventing a flow of electricity to the oscillator tube 78. In the illustrated embodiment, the contactor 82 is electrically connected to the control means 66. In this regard, processor 66 is configured to cause the contactor 82 to move between the closed first position and the open second position.

The oscillator tube 78 is positioned in an oscillator circuit and is configured to generate energy for a plate circuit.

The first capacitor 84 is positioned in the plate circuit. The first capacitor 84 is a tunable capacitor is configured for tuning the plate circuit and functions as a power control capacitor. As used herein, the term “tuning the plate circuit” refers to the process of configuring the plate circuit such that a desired amount of energy is provided to first die 64 under set-up conditions. As used herein, the term “set-up conditions” refers to the electrical and physical characteristics of the electrical components provided for generating and controlling RF energy. In one embodiment, the first capacitor 84 is a plate capacitor formed of two plates 85 that together define a gap 86 such that the width of gap 86 can be varied. The first capacitor 84 could be any other capacitor, but is preferably a variable capacitor.

The second capacitor 87 is also located in the plate circuit. The second capacitor includes what is commonly referred to as the tooling or welding die, i.e., the first die 64 and the second die 65. During a welding process, or cycle, the thermoplastic layers 18 are positioned between the first die 64 and the second die 65 such that the thermoplastic layers 18 function as a dielectric of the second capacitor 87.

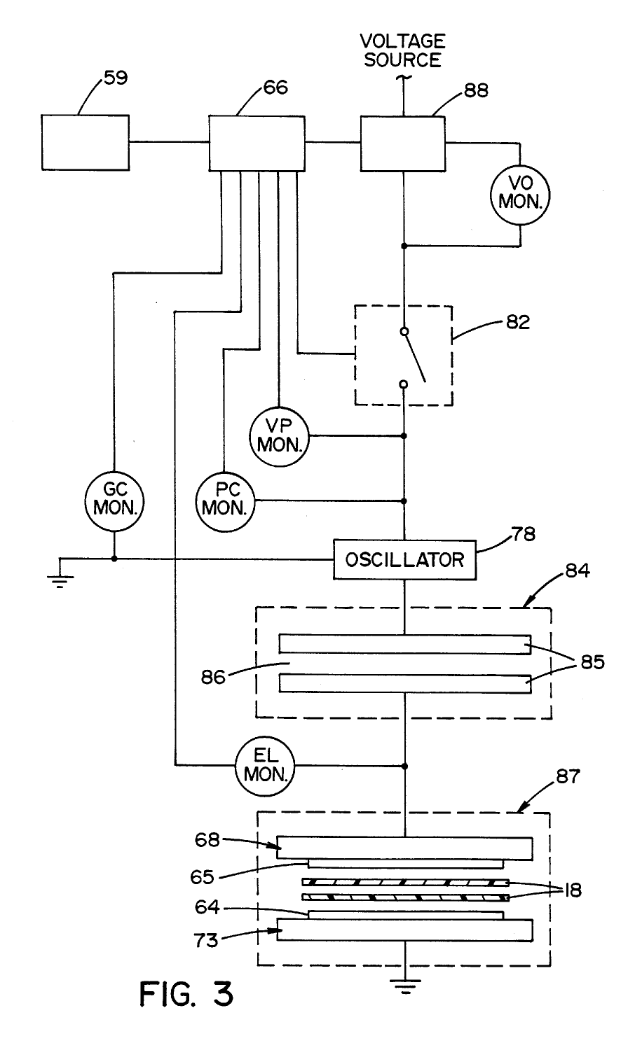

As used herein, the term “grid current” refers to the current in the oscillator circuit. As used herein, the term “plate current” refers to current in a plate circuit. Grid current GC and plate current PC are measured, i.e., monitored, at the locations in the electrical circuits indicated in FIG. 3. More specifically, the grid current is measured between a grid component of the oscillator tube 78 and ground, and plate current is measured between the voltage controller 88 and the oscillator tube 78. In other embodiments, the plate current is measured between the oscillator tube 78 and the first capacitor 84.

The present invention can be better understood by a general description of the operation thereof. The thermoplastic sheets 18 are positioned in a working area of the welding press 61. The pressing means 74 displaces the upper platen 68 and/or the lower platen 73 so that pressure may be alternately applied to the thermoplastic sheets and released from the thermoplastic layers. The heating means 63 pre-heats the upper platen 68 and/or the lower platen 73. Thus, the temperature of the thermoplastic sheets 18 is rapidly raised once the sheets are positioned in the welding press 61 and pressure is applied to the sheets by the pressing means 74. The heat from the upper platen 68 and the lower platen 73 is thermally transferred to the thermoplastic sheets 18 so that the temperature of the sheets is raised to a first predetermined temperature T1. Then the first die 64 and the second die 65 conduct high frequency energy generated by the oscillator 78 to the thermoplastic sheets 18 such that the sheets are at a second predetermined temperature T2.

The high frequency conducted to the thermoplastic sheets 18 by the dies 64 and 65 is then discontinued so that the temperature of the thermoplastic sheets 18 in the area of the welded seam is rapidly lowered from the second temperature T2 to the first predetermined temperature T1. Thus, the thermoplastic sheets 18 softened by the high frequency energy at the second temperature T2 fuse together in the area of the welded seam to form the welded seam. Preferably, the pressing means 74 continues to apply pressure to the thermoplastic sheets 18 for a predetermined period of time such that, prior to release, the welding process provides cooling time under applied pressure once the thermoplastic sheets 18 plasticize. Accordingly, the thermoplastic sheets 18 fuse together completely in the area of the welded seam and an integral welded seam is achieved.

The processor 66 activates and deactivates the pressing means 74 to first apply pressure to the thermoplastic sheets 18 and to then release pressure from the thermoplastic sheets. The processor 66 varies the amount of pressure applied by the pressing means 74 to form welded seams having excellent seam integrity. The optimum amount of pressure to be applied to the thermoplastic sheets 18 in the area of the welded seam is determined by the particular thermoplastic materials, the thickness of the thermoplastic sheets 18, and the duration of time that the pressure is applied to the sheets. The processor 66 further activates and deactivates the oscillator tube 78 to first produce and conduct the high frequency energy to the thermoplastic sheets 18 via the first die 64 and the second die 65 and to then discontinue producing and conducting the high frequency energy to the thermoplastic sheets.

The present invention can be better understood with further reference to the specific operation thereof. The process of welding a pair of thermoplastic sheets 18 together is referred to as a cycle. It should be appreciated that many cycles of welding similar thermoplastic sheets 18 using first die 64 and second die 65 can be performed after an initial set up procedure is performed.

Referring now to the set up and adjustment of the RF welding machine before a cycle or series of cycles, the first capacitor 84 is adjusted to provide a predetermined capacitance. The predetermined capacitance is chosen to allow the desired amount of current through the plate circuit. In this regard, the plate circuit is a tuned circuit and in one embodiment, the predetermined capacitance is approximately equal to that required to maximize the energy transmission to the second capacitor 87, or the tooling, from the oscillator. In another embodiment, it is chosen to optimize the amount of energy applied to the thermoplastic layers 18. In this regard, the optimum amount of energy applied to the thermoplastic sheets 18 is the minimum amount of energy that is sufficient to cause the thermoplastic sheets to be welded together such that the weld is consistent.

In one embodiment, the capacitance of the first capacitor 84 is adjusted by manually changing width of the gap 86 shown in FIG. 3. Alternatively, the gap 86 could be varied by a servo-motor or other mechanical device attached to the plates. In a preferred embodiment, a threaded adjustment rod (not shown) is configured to reposition at least one of plates 85 by turning. This movement of the at least one of plates 85 causes the width of the gap 86 to change.

In a preferred embodiment, the contactor 82 is in the closed first position before a process cycle is initiated. It is believed that by closing contactor prior to applying voltage to the contactor, the life of the contactor can be greatly extended. In this regard, opening and closing contactor 82 while voltage is applied to the contactor 82 can cause electrical arcing between components of the contactor 82. This electrical arcing can generate heat that damages the contactor. Therefore, reducing the amount of electrical arcing that occurs by applying voltage to contactor 82 when it is in the closed first position should extend the life of the contactor 82.

The present invention provides a method that includes the step of positioning the thermoplastic sheets 18 in the working area 52 of the welding press 61 between the upper platen 68 and the lower platen 73. In this manner, the second capacitor 87 is formed.

The method further includes the step of applying pressure to the thermoplastic sheets 18. In this regard the upper platen 68 and/or the lower platen 73, are displaced toward the opposing platen. The method further includes the step of conducting high frequency energy to the thermoplastic sheets 18. Preferably, the processor 66 activates the oscillator 78 to produce high frequency energy and activates the second capacitor 87 to conduct the high frequency energy to the thermoplastic sheets 18 in the area of the welded seam. Activation of the oscillator 78 causes the temperature of thermoplastic sheets 18 in the area of the welded seam to rise to the predetermined temperature T2. A method of controlling the amount of RF energy conducted to the thermoplastic sheets 18 is described in detail below.

After the thermoplastic sheets 18 are heated, then the processor 66 deactivates the energy generator so that high frequency energy is no longer produced and conducted by the RF first die 64 to the thermoplastic sheets. Deactivation of the oscillator 78 preferably occurs after the thermoplastic sheets 18 plasticize in the area of the welded seam. In a preferred embodiment, the oscillator is deactivated by opening the contactor 82 by moving it from the closed first position to the open second position. After the contactor is open, the processor 66 causes the voltage controller 88 to drop the voltage output. The voltage output can be lowered such that it is substantially zero.

The method further includes the step of discontinuing applying pressure to the thermoplastic sheets 18.

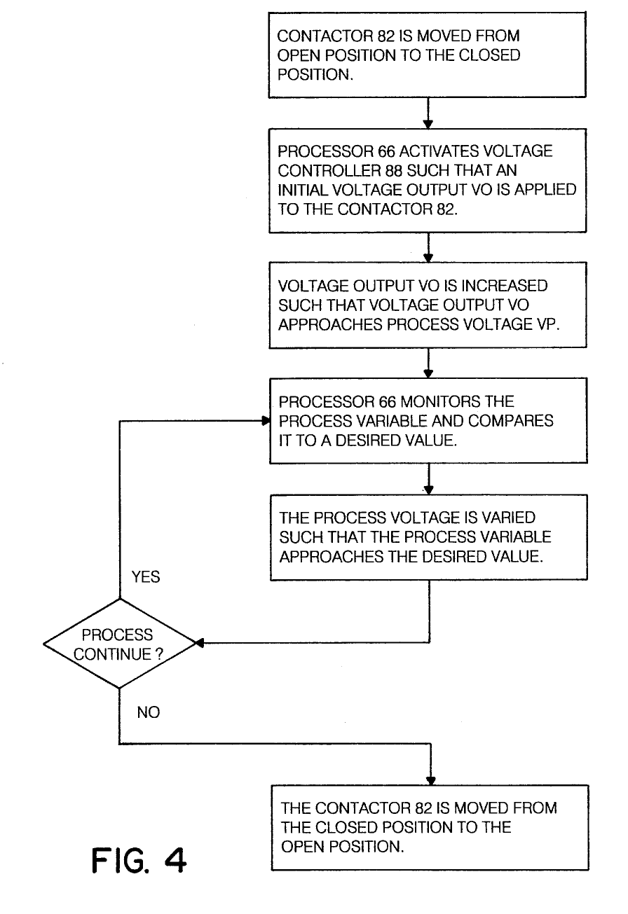

Referring now to a method for controlling the power output of the welding machine shown as a flow diagram as FIG. 4, the processor 66 provides a signal to the voltage controller 88 to produce a voltage output VO. In one embodiment, the voltage output VO of the frequency drive is initially substantially lower than a process voltage VP. In the illustrated embodiment, the process voltage VP is monitored between the contactor 82 and the oscillator tube 78 as shown on the circuit in FIGS. 2 and 3. It should be appreciated that in other embodiments the process voltage VP is monitored at other points, such as between the oscillator tube 78 and the first capacitor 84, between the first capacitor 84 and the second capacitor 87, and between the voltage controller 88 and the contactor 82. It should also be appreciated that the voltage output VO can be equal to the process voltage VP.

The voltage output VO is then increased incrementally such that the process voltage VP approaches, and eventually reaches, a predetermined level. This increase in voltage VP can follow a generally smooth and continuous curve or it can progress stepwise over time. A stepwise increase occurs when the voltage VP is increased to a first value and maintained there for a predetermined period. This is repeated until the process voltage VP generally reaches the predetermined level.

After the process voltage VP is at the predetermined level, the control means then compares VP to a predetermined voltage set point, VS. The predetermined voltage set point can be entered by an operator through an operator interface 59 or it can be retrieved from a storage means (not shown) by the control means 66. The processor 66 then provides signals as necessary to cause the output of the frequency drive to vary such that the process voltage VP is generally equal to the voltage set point VS.

The voltage set point VS is chosen such that the energy, i.e. power, transmitted through the load to the thermoplastic layers 18 is at a predetermined level. In one embodiment the voltage set point is chosen such that the plate current PC is at a predetermined level. Because the plate current PC is maintained at a predetermined level, the power transmitted through the dies is generally maintained at a predetermined level.

Alternatively, the controller is configured to monitor the grid current GC of the oscillator circuit. The grid current GC is compared to a Grid current set point value. The processor 66 then causes the process voltage VP to change such that the grid current GC approaches the grid current set point, thus generally maintaining the power transmitted through the dies is at the predetermined level.

In another alternative embodiment, the controller 66 is configured to monitor the plate current PC. In this embodiment, the processor 66 is configured to compare the plate current PC to a desired plate current setpoint value. The processor 66 then causes the process voltage VP to change accordingly such that the plate current PC approaches the plate current set point. In a similar embodiment, the processor 66 changes the voltage set point, described above, to change such that the plate current approaches the plate current set point. In this embodiment, the control means indirectly controls plate current by controlling the process voltage. It should be appreciated that the grid current GC can be controlled in a like manner.

Alternatively the predetermined voltage can be determined by the controller based on the current. In this embodiment, the current is monitored and compared to a predetermined current value, or current set point, and the controller adjusts the voltage set point such that the current approaches the current set point.

The apparatus and method provided by the present invention allows for relatively precise control of the power applied to thermoplastics being welded in a radio frequency welding machine. One advantage of the present invention is that such relative precision allows for satisfactory welds to be produced with less energy consumption than used in conventional methods. In this regard, because of the variation of power applied to the thermoplastics in conventional methods, the average power applied must be raised above the minimum, most efficient level such that the weld can be formed as desired. Another advantage of the present invention is that the power provided to the thermoplastic for welding can be maximized to increase the rate of welding with less risk of causing holes in the thermoplastic.

In a further alternative embodiment, an electrical property EL at or near the load of the plate circuit is monitored by the control means positioned at the location in the circuit as shown in FIG. 3. In this embodiment, the process voltage VP is adjusted to maintain a predetermined value of electrical property EL. By way of example and not limitation, the electrical property EL monitored at the load is current, voltage, or some other suitable electrical property or derivative of an electrical property. In this embodiment the power output of the RF welder at the load, or second capacitor 87, is essentially controlled directly resulting in more uniform and consistent power output.

As described above, it is believed that the apparatus and control method of the present invention maintains the power applied to the thermoplastic layers 18 such that the power varies less than according to previously known control methods. The variations in power can result from variations in voltage from the voltage source and plate current. Plate current may vary due to variations of capacitance of the first capacitor 84 or second capacitor 87. Changes of capacitance of the first capacitor 84 can be caused by changes in air temperature or humidity for a plate capacitor such as the first capacitor 84. Variations of the capacitance of the second capacitor 87 formed by the first die 64 and the second die 65 and the thermoplastic layers can occur as the thermoplastic sheets 18 are heated and melted.

The foregoing has described a radio frequency welding machine and method for operating the radio frequency welding machine for maintaining a generally constant power output for welding thermoplastics. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

1. A radio frequency welding apparatus for joining multiple layers of thermoplastic materials, the apparatus comprising:
an electrical voltage source;
a radio frequency energy generator configured to be electrically connected to the electrical voltage source,
a first die and a second die configured to form a tooling capacitor when a dielectric is positioned between the first die and the second die, wherein the tooling capacitor is electrically connected to the radio frequency energy generator and the dielectric includes a thermoplastic sheet;
a processor electrically connected to the voltage source and configured to monitor an electrical property applied to the electric circuit and vary voltage supplied to the radio frequency generator such that the electrical property approaches a predetermined value;
the radio frequency energy generator being configured to provide energy to the tooling capacitor in the form of electromagnetic waves; and
wherein the amount of energy provided to the tooling capacitor is a function of the voltage applied to the tooling capacitor.

2. A radio frequency welding apparatus according to claim 1, further comprising a power control capacitor that is electrically positioned between the radio frequency generator and the tooling capacitor.

3. A radio frequency welding apparatus according to claim 1, wherein the monitored electrical property is current.

4. A radio frequency welding apparatus according to claim 3, wherein the current is monitored between the voltage source and the radio frequency generator.

5. A radio frequency welding apparatus according to claim 3, wherein the current is monitored between the oscillator tube and an electrical ground.

6. A radio frequency welding apparatus according to claim 1, wherein the monitored electrical property is voltage.

7. A radio frequency welding apparatus according to claim 1, wherein the voltage is monitored between the voltage controller and the radio frequency generator.

8. A radio frequency welding apparatus according to claim 1, wherein when the electrical property approaches the predetermined value, the amount of energy provided to the tooling capacitor approaches a second predetermined value.

9. A method for controlling the power output of a radio frequency welding machine, comprising the steps of:
providing a radio frequency welding apparatus that includes a radio frequency energy generator, a first die and a second die configured to form a tooling capacitor when a dielectric is positioned between the first die and the second die, wherein the tooling capacitor is electrically connected to the radio frequency energy generator; a processor electrically configured to monitor and control an electrical property; and the radio frequency energy generator being configured to connected to a voltage source and to provide power to the tooling capacitor in the form of electromagnetic waves, wherein the power is a function of the electrical property;
applying a voltage to the radio frequency energy generator;
monitoring the electrical property;
comparing the electrical property to the first set point; and
adjusting the voltage such that the monitored electrical property approaches a first set point and thereby controlling power applied to thermoplastic sheets positioned between the first die and the second die and thereby forming the dielectric of the tooling capacitor.

10. A method according to claim 9, wherein the electrical property is current.

11. A method according to claim 9, wherein the current is monitored between the voltage source and the radio frequency generator.

12. A method according to claim 9, wherein the current is monitored between the radio frequency generator and an electrical ground.

13. A method according to claim 9, wherein the monitored electrical property is voltage.

14. A method according to claim 9, wherein the voltage is monitored between the voltage controller and the radio frequency generator.

15. A method according to claim 9, further comprising the step of providing a contactor having a closed first position and an open second positioned between the voltage source and the radio frequency generator.

16. A method according to claim 15, further comprising the step of moving the contactor from the open second position to the closed first position before the step of applying a voltage to the radio frequency generator.

17. A method according to claim 9, wherein the step of adjusting the voltage includes at least one step of increasing the voltage such that the electrical property incrementally approaches the first set point.

18. A radio frequency welding apparatus for joining multiple layers of thermoplastic materials, the apparatus comprising:
an electrical voltage source;
an oscillator tube configured to be electrically connected to the electrical voltage source,
a variable first capacitor electrically connected to the oscillator tube;
a second capacitor electrically connected to the first capacitor and electrically positioned such that the first capacitor is between the oscillator tube and the second capacitor;
a processor electrically connected to the voltage source and configured to vary the amount of voltage provided to the oscillator tube and configured to monitor at least one electrical property of a circuit that includes the voltage source, the oscillator tube, the first capacitor, and the second capacitor; and
wherein the second capacitor includes multiple thermoplastic layers to be welded.

19. A radio frequency welding apparatus according to claim 18, wherein the monitored electrical property is current.

20. A radio frequency welding apparatus according to claim 19, wherein the current is monitored between the voltage source and the radio frequency generator.
